(19) United States
(12) Patent Application Publication
(10) Pub. No.: US 2006/0285606 A1
(43) Pub. Date: Dec. 21, 2006

(54) Quantized Power Control in Multiple Antenna Communication System

(75) Inventors: Mohammad A. Khojastepour, Plainsboro, NJ (US); Xiaodong Wang, New York, NY (US); Mohammad Madihian, Plainsboro, NJ (US)

Correspondence Address: NEC LABORATORIES AMERICA, INC., 4 INDEPENDENCE WAY, PRINCETON, NJ, 08540, US

(73) Assignee: NEC LABORATORIES AMERICA, INC., Princeton, NJ (US)

(21) Appl. No.: 11/421,668

(22) Filed: Jun. 1, 2006

Related U.S. Application Data
(60) Provisional application No. 60/686,357, filed on Jun. 1, 2005.

(51) Int. Cl. H04L 1/02

(52) U.S. Cl. 375/267

(57) ABSTRACT

A power control design for multiple antenna communication systems is herein disclosed which uses an optimized quantized feedback link between the receiver and the transmitter.

This application claims the benefit of and is a nonprovisional of U.S. Provisional Application No. 60/686,357, entitled “QUANTIZED POWER CONTROL IN MULTIPLE ANTENNA COMMUNICATION SYSTEM,” filed Jun. 1, 2005, the contents of which are incorporated by reference herein.

### BACKGROUND OF INVENTION

The invention relates generally to wireless communication systems and, more particularly, to power control in multiple antenna communication systems.

It has been shown that wireless communication systems with multiple antennas provide significant performance improvements and achievable data rates over single antenna systems in fading environments. The performance gains can be considerably higher if knowledge of the channel state information is available. Although perfect channel state information is obviously desirable, it is often only possible to have an estimate of the channel state information at the receiver in practical systems. Moreover, the receiver is usually limited to using a feedback link with a very limited capacity (e.g., a few bits of feedback per block of transmission) when providing the channel state information to the transmitter. The transmitter can then use channel state information to maximise the mutual information in each block (typically referred to as “beamforming”) or to assign different power allocations for different blocks (which is typically referred to as “power control”).

It has been previously proposed to use a low rate feedback link for the purposes of beamforming. Nevertheless, it would be advantageous to provide a scheme with less complexity in design and deployment and which would have better performance at high signal-to-noise ratios.

### SUMMARY OF INVENTION

A power control design for multiple antenna communication systems is herein disclosed which uses an optimized quantized feedback link between the receiver and the transmitter. The power levels are partitioned so as to avoid outage for all channel conditions in all of the partitions except a last partition. An optimized form for the power control allocations is disclosed which, advantageously, can be implemented with a low-rate (as little as one or a few bits) feedback link. In accordance with one embodiment, an equivalent model is introduced wherein the multidimensional channel can be represented by a one dimensional channel representation with a new probability distribution function, thereby simplifying the design of the quantized feedback. In accordance with another embodiment, a pre-evaluation of the system performance can be performed which incorporates the effects of finite constellation size, (de)modulation, performance of inner and outer codes, and the effect of errors in the feedback link. The optimal solution form and channel ordering can be adopted, while the pre-evaluationg assesses the frame error probability of the actual system instead of the outage probability.

These and other advantages of the invention will be apparent to those of ordinary skill in the art by reference to the following detailed description and the accompanying drawings.

### BRIEF DESCRIPTION OF DRAWINGS

FIG. 1 illustrates a coded multiple-input multiple-output (MIMO) system, suitable for practice of an embodiment of the invention.

FIG. 2 is a graph representing the optimal power allocation for a multiple antenna system with L=4 quantized levels (2 bits) of feedback.

FIG. 3A through 3C are graphs representing (A) an optimal power allocation versus (B), (C) two suboptimal power allocations for a multiple antenna system with 1-bit quantized feedback.

FIG. 4 through 6 are graphs representing the performance of a 4×4 MIMO system exploiting a rate R=4 BLAST inner code and an LDPC outer code of length 2048 and rate ½ using QPSK modulation. The different figures illustrate different thresholds π. A family of curves shows the performance with different power levels in each region. The envelope of the plotted family of the curves shows the achievable performance with one bit of feedback. The tangent point in each curve with the envelope shows the optimal values of the powers in each region for the available average power.

### DETAILED DESCRIPTION

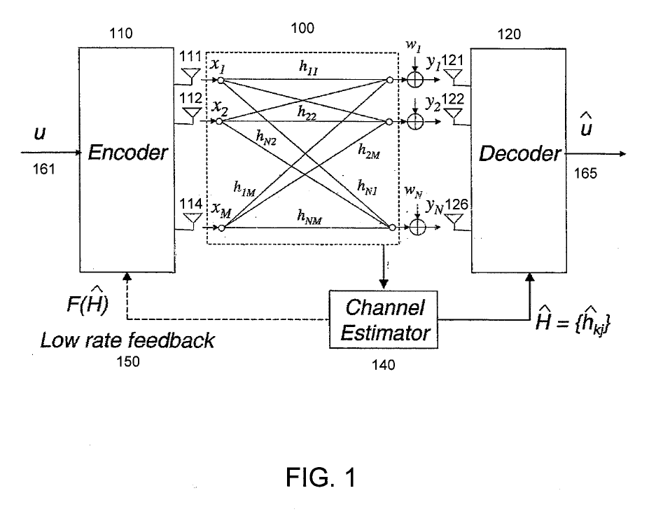

FIG. 1 is an abstract illustration of a coded multiple-input multiple-output (MIMO) system, suitable for practice of an embodiment of the invention.

As depicted in FIG. 1, the multiple antenna system has M transmit antennas 111, 112, . . . 114 and N receive antennas 121, 122, . . . 126 which communicate across a channel 100. It is assumed that the system utilizes some form of coding scheme with an encoder 110 at the transmitter and a corresponding decoder 120 at the receiver. The multiple antenna system can be modeled as follows: the received signal can be represented by a vector Y_{N×1} such that
y=Hx+w, (1)
where X_{M×1} is a vector representing the transmitted symbols, H_{N×M} represents the channel matrix, and w_{N×1} is a circularly symmetric complex additive white Gaussian noise with zero mean and variance one. Consider a block fading channel model in which the channel remains constant during transmission of each packet (or codeword of length T) and changes independently from one block to another block, where the distribution of the channel state is known a priori. The average power constraint on the transmissions can be expressed as E[x^{H}x]≦P. Equivalently, since tr(xx^{H})=tr(x^{H}x) and the expectation and trace commute, this can be expressed as E[x^{H}x]≦P. The channel model can be alternatively represented as
Y_{N×T}=H_{N×M}X_{M×T}+W_{N×T,} (2)
where a codeword X=(x₁x₂ . . . x_{T}) and the received vectors of Y=(y₁y₂ . . . y_{T}) are considered over the block length T in which the channel is constant. The power constraint can then be expressed as Etr[X^{H}X]≦PT, where PT is the total average power constraint per transmission block of length T.

The channel matrix H can be adapted to represent a wide range of different cases of fading, e.g., the discussion below is applicable to an independent and identically distributed (i.i.d.) block fading channel model as well as a correlated fading model, rank deficient channels such as keyhole channel, and Rician fading in presence of line of sight. For illustration herein, we consider an (i.i.d.) Rayleigh channel model which means the elements of the channel matrix H are independent and identically distributed circularly symmetric complex Gaussian random variables with mean zero and variance one.

The multiple antennas system is assumed to have a channel estimator 140 at the receiver and a low rate feedback link 150 between the receiver and the transmitter. The channel estimator 140 is used to compute channel state information at the receiver. Partial channel state information is then available to the transmitter through the finite rate feedback link 150. From a practical point of view, a small rate of feedback can be considered to be available from the destination to the source without wasting too much of the system resources. However, no matter how low the feedback rate is, because of the fading there is a probability of outage in receiving the crucial feedback information at the transmitter in which our design strategy depends. Therefore, it is important to incorporate the possibility of the outage (or lost in feedback information) in the design of finite rate feedback strategies.

The outage probability can be considered as a lower bound to the probability of error in communication system. This bound is approachable by using an effective coding scheme, a proper input alphabet, and long enough codes. For coding schemes such as space-time block codes or linear dispersion codes, it is possible to express the outage probability in a closed form in terms of an effective channel matrix H.

For example, where the transmission code is a linear dispersion code, each block of transmitted signals of length T are linear combinations of Q independent transmitted symbols, q₁, q₂, . . . , q_{Q} as defined by

$$X = {\sum }_{q = 1}^{Q} ( {s}_{q} {C}_{q} + {s}_{q}^{*} {D}_{q} ) . \qquad ( 3 )$$

The matrices C_{q} and D_{q} for q=1, 2, . . . , Q completely determine the code structure and are referred to as the dispersion matrices, where the codewords are obtained through choices of independent symbols q₁, q₂, . . . , q_{Q}. In order to find the effective channel model, s_{q} can be decomposed into the real and imaginary parts and rewritten in the following form

$$X = {\sum }_{q = 1}^{Q} ( Re ( {s}_{q} ) {A}_{q}^{T} + Im ( {s}_{q} ) {B}_{q}^{T} ) \qquad ( 4 )$$

where A_{q}=(C_{q}+D_{q})^{T} and B_{q}=(C_{q}−D_{q})^{T}. For any vector z ε C^{N} and a matrix A ε C^{N×M}, define

$$\begin{matrix}\hat{z} = [ \begin{matrix}Re ( z ) \\ Im ( z )\end{matrix} ] , \\ and & ( 5 ) \\ \hat{A} = [ \begin{matrix}Re ( z ) & - Im ( z ) \\ Im ( z ) & Re ( z )\end{matrix} ] . & ( 6 )\end{matrix}$$

The equivalent real channel matrix Ĥ can be written as

$$\hat{ℋ} = {[ \begin{matrix}{\hat{A}}_{1} {h}_{1} & {\hat{B}}_{1} {h}_{1} & ⋯ & {\hat{A}}_{Q} {h}_{1} & {\hat{B}}_{Q} {h}_{1} \\ ⋮ & ⋮ & ⋮ & ⋮ & ⋮ \\ {\hat{A}}_{1} {h}_{N} & {\hat{B}}_{1} {h}_{N} & ⋯ & {\hat{A}}_{Q} {h}_{N} & {\hat{B}}_{q} {h}_{N}\end{matrix} ]}_{2 NT \times 2 Q} , \qquad ( 7 )$$

and the equivalent channel model is given by
Y=Hs+w (8)
where s=[s₁s₂ . . . s_{Q}]^{T}. It can be shown that the outage probability for the attempted rate of transmission equal to R is given in terms of the equivalent channel model as

$${P}_{out} ( R , P ) = Prob ( \frac{1}{T} log det ( I + \frac{P}{M} {ℋℋ}^{H} ) < R ) . \qquad ( 9 )$$

The quantized power control problem can then be formulated as

$${Minimize}_{𝒫 , P ( γ ) ∈ 𝒫} Prob ( log det ( I + \frac{P ( γ )}{M} γ ) < R ) . \qquad ( 10 )$$

subject to
E[P(γ)]≦P (11)
where P is the long term average power, γ=HH^{H} is the effective channel quality, P Δ{P₁, P₂, . . . , P_{L}} is a fixed power level codebook with L number of the power levels, and P(γ) is a quantized power strategy which maps any points from the set of the effective channel qualities γ ε Γ to a power level in P. The feedback link provides finite number of signals, e.g., L, to the transmitter which corresponds to a quantized γ=HH^{H}. Clearly, the most efficient use of the feedback signal at the transmitter for power control is to use a different power level Pᵢ for each feedback signal i ε {1, 2, . . . , L}. Therefore, for q bits of feedback, we need to find L=2^{q}−1 power levels P₁, P₂, . . . , P_{L} and a mapping function
P(γ): Γ→P (12)
where P={P₁, P₂, . . . , P_{L}} such that the outage probability is minimized while the long term average power is satisfied. Therefore, the set of Γ is partitioned into L sets of Γ₁, Γ₂, . . . , Γ_{L} such that if for a block of transmission γ ε Γᵢ then the feedback signal i is sent to the transmitter and the associated power level Pᵢ will be used in this block.

It is useful to define what the inventors refer to as an outage avoiding power P*(γ) for a given channel realization. For any γ, the power level P*(γ) is called an outage avoiding power if it is the least power required to have zero outage. It is also useful to define an ordering on the channel realization matrix H. For a given outage minimization problem which employs a fixed coding scheme (not depending on the feedback) of rate R, a channel realization H₁ is called to succeed the channel realization H₂ and written as
H₁ [symbol] H₂ (13)
if the required outage avoiding powers P*(γ) and P*(γ₂) are such that P*(γ₁)<P*(γ₂). Similarly, a channel realization H₁ is called to precede the channel realization H₂ and written as
H₁ [symbol] H₂ (14)
if P*(γ₁)>P*(γ₂). In case that P*(γ₁)=P*(γ₂), two channel realizations are called equivalent.

Without loss of generality, it is assumed that the power levels are such that P₁>P₂>. . . >P_{L} corresponding to the partition Γ₁, Γ₂, . . . , Γ_{L}. It can be shown that the optimal solution to the quantized power control feedback problem, avoids outage for all the channel conditions in the first L−1 partitions, and lets the outage occur only in the last partition, Γ_{L}. Moreover, the partitioning of optimal solution is such that a channel condition γ either belongs to (i) the partition Γᵢ with maximum index that can guarantee no outage for this channel quality, or (ii) this channel condition belongs to G_{L}. This aspect of the structure of the optimal solution can be expressed more formally as follows. Let P(γ) ε P,P={P₁,P₂, . . . , P_{L}} be the optimal solution for the optimization problem expressed in equation (10), where P₁>P₂>. . . >P_{L}. Then, for all γ except in a set of measure zero
∀ᵢ, 1≦i≦L−1: P(γ)=Pᵢz,3 Pᵢ₊₁<P*(γ)≦Pᵢ
otherwise P(γ)=P_{L}, i.e., [symbol] P*(γ)≦P_{L} or P₁<P*(γ)
A proof of this result is provided in the APPENDIX.

As further discussed herein, it can then be shown that the optimal L level quantized power allocation function P(γ, R) has the following form
P(γ,R)=Pᵢ if γ ε [γᵢ, γᵢ₊₁) for all i ε {1, 2, . . ., L−1} (15)
and
P(γ,R)=P_{L} if γ ε [0,γ₁)∪[γ_{L},∞) (16)
for some 0<γ₁<γ₂< . . . <γ_{L}<∞, where the ith power level is given by

$${P}_{i} = \frac{{ⅇ}^{R} - 1}{{γ}_{i}} , for all i ∈ \{ 1 , 2 , … , L - 1 \} . \qquad ( 17 )$$

Therefore, the minimum outage probability can be equivalently be written as

$${P}_{out} ( R , P ) = Prob ( γ < {γ}_{1} ) = {\int }_{{γ}_{1}}^{∞} {f}_{γ} ( γ ) ⅆ γ \qquad ( 18 )$$

It is useful to define an equivalent one dimensional channel which provides a better visual interpretation of the problem and its solution. For a general M×N multiple antenna outage minimization problem which employs a fixed coding scheme (not depending on the feedback) of rate R and the multi-dimensional channel quality γ=HH^{H}, the equivalent M×1 multiple antenna systems with a one-dimensional channel quality η is defined as a channel for which η has the following cumulative density function
F_{η}(η₀) [symbol] Prob(η≦η₀)=Prob(γ≦γ₀) (19)
where γ₀ is such that
P*(γ₀)=Q*(η₀) (20)
and P*(.) and Q*(.) are the outage avoiding power function for the original M×N multiple antenna system and a M×1 system employing a known coding scheme such as BLAST coding, respectively. It can be easily verified that the above definition provides a valid random variable η, i.e., the cumulative distribution function F_{η}(η) is between zero and one, and it has right continuity property. Moreover, the equivalent one dimensional channel has the same outage behavior as the original channel, i.e., the outage with or without channel state information at the transmitter and in particular outage with finite feedback for both systems are similar.

The cumulative probability density function of the equivalent one-dimensional channel quality, F_{η}(η) is usually very easy to compute. Consider a M×N·multiple antenna system for which the distribution of the channel matrix H is known, e.g., Rayleigh. Using Monte-carlo simulation, we can take samples of H from its distribution and compute samples of the equivalent channel matrix H for a given coding scheme. Then, we can find the eigenvalue decomposition of the multi-dimensional channel quality, γ=HH^{H}, and rewrite the outage probability as

$$\begin{matrix}{P}_{out} ( R , P ( . ) ) = Prob ( log det ( I + \frac{{P}_{H} ( ℋ )}{M} {ℋℋ}^{H} ) < R ) & ( 21 ) \\ = Prob ( log det ( I + \frac{P ( γ )}{M} γ ) < R ) & ( 22 ) \\ = Prob ( {\sum }_{k = 1}^{K} log ( 1 + \frac{P ( γ )}{M} {λ}_{k} ) < R ) & ( 23 )\end{matrix}$$

where λₖ's are K distinct nonzero eigenvalues of the channel quality matrix γ=HH^{H}. Therefore the probability

$${P}_{out} ( R , P ) {\vert}_{P = \frac{{ⅇ}^{R} - 1}{η}}$$

is equal to F_{η}(η) that is the cumulative distribution of the equivalent one-dimensional channel quality η.

It should be pointed out that although the eigenvalue decomposition of γ does not necessarily reduce the computational complexity in finding F_{η}(η), it fairly speeds up the algorithm to find the outage avoiding power function P*(γ) which is used to perform the channel ordering. However, if the BLAST code is used in a Rayleigh fading environment, the eigenvalues of the channel quality matrix γ=HH^{H} follows Wishart distribution with parameter M, N defined as

$${f}_{ordered , λ} ( {λ}_{1} , {λ}_{2} , … , {λ}_{m} ) = {K}_{m , n}^{- 1} {ⅇ}^{- {\sum }_{i}^{} {λ}_{i}} {\prod }_{i}^{} {λ}_{i}^{n - m} {\prod }_{i < j}^{} {( {λ}_{i} - {λ}_{j} )}^{2} \qquad ( 24 )$$

where m=min{M, N}, n=max{M, N}, and K_{m,n} is a normalization factor. In this case, one can directly benefit in reducing the complexity in calculating F_{η}(η) by directly generating the eigenvalues λ instead of the M×N dimensional channel matrix H.

For multiple transmit and one receive antenna systems, the channel matrix H is an M×1 dimensional matrix and the corresponding γ=HH^{H} is a chi-squared statistics with 2M degrees of freedom. In this case, it can be shown that the distribution of η=γ is simply given by

$${p}_{γ} ( γ ) = \frac{1}{Γ ( M )} {γ}^{M - 1} {ⅇ}^{- γ} , \qquad ( 25 )$$

where

$$Γ ( a , x ) = {\int }_{0}^{x} {u}^{a - 1} {ⅇ}^{- u} ⅆ u$$

denotes the incomplete gamma function. Similarly for the one transmit and N receive antenna case, the equivalent one-dimensional channel quality has a chisquared distribution with 2N degrees of freedom.

In some cases the distribution of the equivalent one-dimensional channel quality can be well approximated with an analytical expression. For example, for a four transmit and four receive antenna system which uses BLAST with rate R=1, the equivalent one-dimensional channel quality can be approximated with a chi-square distribution with forty degrees of freedom that is equivalent with the distribution of the channel quality for a system with twenty transmit and one receive antennas. While we cannot furnish any proof or intuition why this is the case, our monte-carlo simulation shows the accuracy of such an approximation. Since these two systems have exactly the same outage behavior for any power allocation strategy, it is then possible to use the closed form expressions for the distribution of η to find the optimal quantized power allocation strategy.

However, it should be noted that the distribution of the channel quality in fact is in general a function of the coding scheme and the chosen rate. In fact the dependency on rate is important except for the cases that either the number of transmit antennas or the number of receive antennas are unity, and hence the distribution becomes independent of the transmission rate.

It worth mentioning that for a multiple antenna with large number of transmit or receive antennas using the BLAST codes, the distribution of the mutual information term in equation (21) closely follows Gaussian distribution, where the mean and variance of the mutual information can be readily found. This approximation might also be used to evaluate the cumulative density function of η in equation (21).

The definition of the one-dimensional channel quality helps to reduce the complexity of the design of the quantized power control strategy for a general multiple antenna system. Design based on the one-dimensional channel quality is similar to the design for a single antenna system where the distribution of the channel quality is not Rayleigh anymore. In fact, this distribution depends on the number of antennas both at the transmitter and the receiver, the used space-time codes (e.g. orthogonal designs, BLAST, or linear dispersion codes), and the rate of the code. It should be pointed out that this distribution for a general multiple antenna system depends on the rate of the code if both the number of transmit and receive antenna is more than one. Moreover, the design based on the one-dimensional channel quality has the advantage that provides a simple representation and visualization of the design procedure. Therefore, it is fairly easy to predict the performance of a multiple antenna system based on the probability density function of its equivalent one-dimensional channel quality.

Using the above results, it is possible to simplify the design of power control for any multiple transmit and multiple receive antenna based on its equivalent one-dimensional channel quality. Therefore, we equivalently consider the optimal power control design for a one dimensional channel with the channel quality η which has follows an arbitrary distribution f_{η}(η). For a simpler discussion, we restrict our analysis to the cases where the density function of η is continuous and nonzero in the interval (0, ∞). This condition is trivially satisfied for the case of Rayleigh fading channel using M×1 or 1×N antenna systems. It is in fact not hard to show that this condition is also satisfied for the general case of M×N transmit antenna systems in Rayleigh fading environment. The following result can then be proven: If the probability density function f_{η}(η) of the equivalent one-dimensional channel quality η is continuous and positive in (0, ∞), then the optimal L level quantized power control for equation (10) has the following form
P(η)=Pᵢ if η ε [ηᵤ,ηᵢ₊₁) for all i ε {1, 2, . . . , L−1} (26)
and
P(η)=P_{L} if η ε [0,η₁)∪[η_{L},∞) (27)
for some 0<η₁<η₂< . . . <η_{L}<∞, where

$${P}_{i} = \frac{{ⅇ}^{R} - 1}{{η}_{i}} , for all i ∈ \{ 1 , 2 , … , L - 1 \} . \qquad ( 28 )$$

The above result can be proved using the same argument as in the APPENDIX, while considering the fact that the set of measure zero in the proof in the APPENDIX will not appear here because of the conditions on f_{η}(η) .

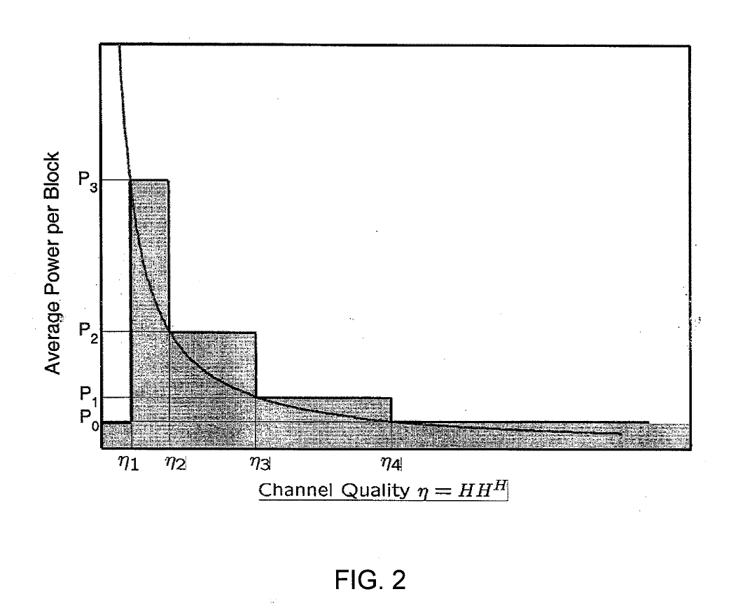

FIG. 2 shows an exemplary visualization of the optimal power allocation strategy with L=4 levels of feedback that corresponds to 2 bits of feedback per block. Using the above result, we can see that the outage event occurs only in the interval [0,ηᵢ) and the outage probability is then defined as
Pₒᵤₜ(R,P(η)=Prob(η<η₁)=F_{η}(η₁) (29)

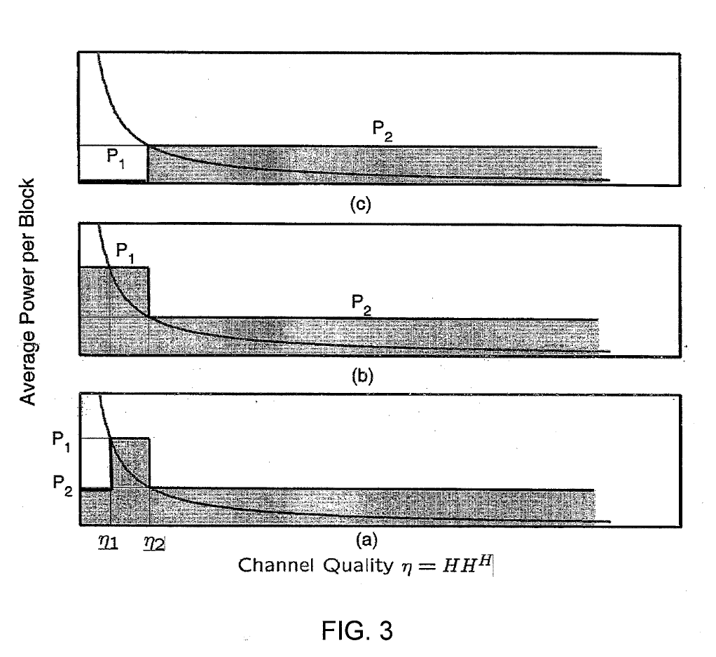

It is instructive to compare the above-described optimal solution to the solution described in S. Bhashyam et al., “Feedback Gain in Multiple Antenna Systems,” IEEE Transactions on Communications, Vol. 50, No. 5, pp. 785-98 (May 2002). It can be appreciated that the above-described optimal solution always strictly outperforms the Bhashyam et al solution. For example, FIG. 3A shows the optimal power control strategy for the one-bit feedback design derived using the above technique. The one-bit feedback design approach of Bhashyam et al considers two different strategies depicted in FIG. 3B and 3C, and then takes the minimum of both solutions. It is immediate that the power control strategy in FIG. 3B is never optimal. In fact, for the same average power and also power level P₂ in both FIG. 3A and B the power level P₁ in FIG. 3A is greater than the power level P₁ in FIG. 3B. Therefore, a lower outage probability can be achieved with the same average power using the optimal strategy of FIG. 3A.

The average power can also be written in terms of the threshold values η₁, η₂, . . . η_{L} as
E[P(η)]=P_{L}F_{η}(η₁)+P₁(F_{η}(η₂)−F_{η}(η₁))+ . . . +P_{L-1}(F_{η}(η_{L})−F_{η}(η_{L-1}))+P_{L}(1−F_{η}(η₁)) (30)
Therefore, the optimization problem can be rewritten in the following form over the vector of the threshold values η=[η₁, η₂, . . . , η_{L}]^{T}

$$\begin{matrix}{min}_{\underline{η}} {η}_{1} & ( 31 ) \\ Subject to 𝔼 [ P ( \underline{η} ) \leq P & ( 32 )\end{matrix}$$

Using standard lagrange multiplier for to solve this constrained optimization problem, we constitute the unconstrained objective function as
J=η₁−λ(E[P(η)]−P) (33)
The stationary point of this optimization problem is then satisfy ∇_{η}=0. Also, using the KKT condition, either λ=0, or we have E[P(η)]=P. Therefore, we have

$${∇}_{\underline{η}} J = [ \begin{matrix}1 - λ \frac{\partial 𝔼 [ P ( \underline{η} ) ]}{\partial {η}_{2}} \\ - λ \frac{\partial 𝔼 [ P ( \underline{η} ) ]}{\partial {η}_{2}} \\ ⋮ \\ - λ \frac{\partial 𝔼 [ P ( \underline{η} ) ]}{\partial {η}_{L}}\end{matrix} ] = 0 \qquad ( 34 )$$

It means that λ satisfies the equality

$$λ \frac{\partial 𝔼 [ P ( \underline{η} ) ]}{\partial {η}_{1}} = 1$$

and we have

$${∇}_{\underline{η}} J = - \frac{1}{\frac{\partial 𝔼 [ P ( \underline{η} ) ]}{\partial {η}_{1}}} [ \begin{matrix}0 \\ - \frac{\partial 𝔼 [ P ( \underline{η} ) ]}{\partial {η}_{2}} \\ ⋮ \\ - \frac{\partial 𝔼 [ P ( \underline{η} ) ]}{\partial {η}_{L}}\end{matrix} ] = 0 \qquad ( 35 )$$

everywhere that ∂E[P(η)]/∂η₁ ≠0. The condition (35) can be further simplified using (32) as

$$\begin{matrix}{∇}_{\underline{η}} J = [ \begin{matrix}0 \\ - \frac{\partial 𝔼 [ P ( \underline{η} ) ]}{\partial {η}_{2}} \\ ⋮ \\ - \frac{\partial 𝔼 [ P ( \underline{η} ) ]}{\partial {η}_{L - 1}} \\ - \frac{\partial 𝔼 [ P ( \underline{η} ) ]}{\partial {η}_{L}}\end{matrix} ] \\ = [ \begin{matrix}0 \\ - {P}_{1} {f}_{η} ( {η}_{2} ) + \frac{{P}_{2}}{{η}_{2}} ( {F}_{η} ( {η}_{3} ) - {F}_{η} ( {η}_{2} ) ) + {P}_{2} {f}_{η} ( {η}_{2} ) \\ ⋮ \\ - {P}_{L - 2} {f}_{η} ( {η}_{L - 1} ) + \frac{{P}_{L - 1}}{{η}_{L - 1}} ( {F}_{η} ( {η}_{L} ) - {F}_{η} ( {η}_{L - 1} ) ) + {P}_{L - 1} {f}_{η} ( {η}_{L - 1} ) \\ - {P}_{L - 1} {f}_{η} ( {η}_{L} ) + \frac{{P}_{L}}{{η}_{L}} ( 1 - {F}_{η} ( {η}_{L} ) - {F}_{η} ( {η}_{1} ) ) + {P}_{L} {f}_{η} ( {η}_{L} )\end{matrix} ] \\ = 0\end{matrix} \qquad ( 36 )$$

Note that the second to the (L−1)^{th} rows are similar, but the last row is different. We can rewrite these set of nonlinear equations in the form
P(η₁)(η₂=η₁) f_{η}(η₂)=P(η₂)(F(η₃)−F(η₂)) (37)
P(η₂)(η₃=η₂) f_{η}(η₃)=P(η₃)(F(η₄)−F(η₃)) (87)
P(η_{L-2})(η_{L-1}−η_{L-2})f_{η}(η_{L-1})=P(η_{L-1})(F(η_{L})+F(η₁)) (39)
P(η_{L-1})(η_{L}−η_{L-1})f_{η}(η_{L})=P(η_{L})(1−F(η_{L})+F(η₁)) (40)
We can conclude from these last set of equations that if the number of power levels goes to infinity, we have

$$( {η}_{i + 1} - {η}_{i} ) {f}_{η} ( {η}_{i + 1} ) \approx {\int }_{{η}_{i}}^{{η}_{i + 1}} {f}_{η} ( η ) ⅆ η = P ( {η}_{i} ) ( F ( {η}_{i + 1} ) - F ( {η}_{i} ) ) \qquad ( 41 )$$

and therefore the average powers for different feedback bits are asymptotically equal. It should be pointed out that for the practical values of the number of feedback bits, the asymptotical approximation of equation (41) is not valid and this set of equation has to be solved to find the stationary point of the optimization problem.

An advantageous numerical technique for solving the constrained outage probability minimization with quantized feedback and for finding the optimal values of the thresholds η₁, η₂, . . . , η_{L} and the associated power levels P₁, P₂, . . . ,P_{L} is to use a gradient descent approach. The numerical algorithms based on the gradient search rely on the fact that if the gradient of the objective function at the current solution point is not zero, by taking an step toward the opposite direction of the gradient, it is possible to find a new point for which the value of the objective function is smaller. However, in practice it is hard to know the right step size. The algorithm may not converge if step size are large, and it may converge way too slow if step size is small. However, there are number of effective algorithm to adjust the step size. The Barzilai-Borwein method is a steepest descent method for unconstrained optimization which has proved to be very effective for most practical applications. The Barzilai-Borwein gradient search method differs from the usual steepest descent method in the way that the step length is chosen and does not guarantee descent in the objective function. Combined with the technique of nonmonotone line search, such a method has found successful applications in unconstrained optimization, convex constrained optimization and stochastic optimization. A number of recent works have also developed and improved the Barzilai-Borwein gradient search method for some cases. Although, the outage minimization problem set forth in equation (31) is a constrained optimization problem, the simplified gradient given by equation (35) is in fact equivalent to the gradient for an unconstrained optimization problem. Based on our understanding of the problem, we know that at the optimal point of the problem (31) the constraint (32) is satisfied with equality. Therefore, we are trying to minimize η₁ as a function of η′=[η₂, η₃, . . . , η_{L}]^{T} where EP(η₁, η′)=P is an implied relation between the independent variables and the objective function. This problem is now an unconstrained optimization problem. We can the calculate the gradient of η₁(η′) by using the implicit relation as

$$\begin{matrix}{∇}_{{\underline{η}}^{′}} {η}_{1} = [ \begin{matrix}- \frac{\frac{\partial 𝔼 [ P ( \underline{η} ) ]}{\partial {η}_{2}}}{\frac{\partial 𝔼 [ P ( \underline{η} ) ]}{\partial {η}_{1}}} \\ - \frac{\frac{\partial 𝔼 [ P ( \underline{η} ) ]}{\partial {η}_{3}}}{\frac{\partial 𝔼 [ P ( \underline{η} ) ]}{\partial {η}_{1}}} \\ ⋮ \\ - \frac{\frac{\partial 𝔼 [ P ( \underline{η} ) ]}{\partial {η}_{L}}}{\frac{\partial 𝔼 [ P ( \underline{η} ) ]}{\partial {η}_{1}}}\end{matrix} ] \\ = - \frac{1}{\frac{\partial 𝔼 [ P ( \underline{η} ) ]}{\partial {η}_{1}}} [ \begin{matrix}- \frac{\partial 𝔼 [ P ( \underline{η} ) ]}{\partial {η}_{2}} \\ - \frac{\partial 𝔼 [ P ( \underline{η} ) ]}{\partial {η}_{3}} \\ ⋮ \\ - \frac{\partial 𝔼 [ P ( \underline{η} ) ]}{\partial {η}_{L}}\end{matrix} ]\end{matrix} \qquad ( 42 )$$

Comparing equations (35) and (43) shows that these gradients are equivalent. Therefore, the gradient search algorithm is then defined as
η^{(k+1)}=η^{(k)}−μₖ∇_{η}J (43)
where the gradient ∇_{η}J is given by equation (35), and μₖ is the sequence step size. This sequence can be either chosen as an appropriate fixed sequence of decreasing positive real numbers such that

$${\sum }_{k = 1}^{∞} {μ}_{k}^{2} < ∞ and {\sum }_{k = 1}^{∞} {μ}_{k} \to ∞ ,$$

or it can be dynamically found through Barzilai-Borwein gradient search which improves the performance of the algorithm and usually converges faster. It should be pointed out that if the probability density function of the equivalent channel condition η is analytically known, the value of the gradient can be found analytically. However, in many practical cases it is simpler to estimate the gradient (35) by using its simplified form (36) through monte-carlo simulation. The gradient search stochastic optimization method is a very powerful technique where the actual gradient and value of the objective function is not known, but it can be well estimated through monte carlo simulation or evaluation of the system performance.

It should be noted that the optimal solution described above assumes
(i) the codes used in each block of transmissions are optimal in the sense that they achieve arbitrarily small probability of error for the rate very close to the instantaneous mutual information of the channel,
(ii) the knowledge of the channel state information at the receiver is perfect and available without wasting any system resources,
(iii) the knowledge of the channel state information at the transmitter is available through a fixed and finite rate of feedback, e.g., log₂ (L) bits of feedback per block of transmission, where the feedback has no error.

However, it should be recognized, e.g., that knowledge of the channel state information at the receiver is obtained through channel estimation which is not perfect in two senses: (i) the estimated value has an error, and (ii) it uses some part of the available system resources. For example, in preamble-based channel estimation for M×N multiple antenna systems, there are MN unknown that can be estimated with finite variance through transmission of a long enough preamble prior to transmission of the actual message. The value of MN unknown channel coefficients can be determined through at least MN independent measurements. Choosing the a simple preamble of the form

$$\sqrt{\frac{{P}_{pre}}{M}} I$$

would be then sufficient and the resulting mutual information of the channel through T (assume T>M is the coherence interval) uses of the channel is then lower bounded by

$$I ( x ; y \vert H ) \geq \frac{T - M}{T} log det ( I + \frac{{P}_{d}}{M ( 1 + {γ}_{p}^{2} {P}_{d} )} \hat{H} {\hat{H}}^{H} ) , \\ where \\ {P}_{d} = \frac{TP - {P}_{pre}}{T - M} \qquad ( 44 )$$

is the total average power used to transmit the actual data, P is the total available average power, and Pₚᵣₑ is the power used in sending preamble to estimate the channel. Therefore, the knowledge of the channel state at the transmitter has a finite variance (or error) in its estimation and is not perfect. Furthermore, this knowledge comes at the price of spending the power Pₚᵣₑ and the time fraction

$$\frac{M}{T}$$

for training as part of the available system resources which is not used to send the actual data.

The performance of a practical finite-length code cannot be captured by the mutual information between the source and destination, even if the finite constellation input is used in the evaluation of the mutual information. In particular, the frame error rate for a practical code behaves very different from that of the optimal code, i.e., not only the frame error rate of a practical code as a function of SNR does not go to zero where the optimal codes achieve zero error rate, but also the drop in the frame error rate versus SNR is not necessarily sharp.

Moreover, for a multiple antenna system the performance of the code also depends on the specific channel realization matrix, H, which make the problem even more involved. To be more specific, the evaluation of the code performance for the two different channel realization of H₁ and H₂ usually shows different behavior even though the instantaneous mutual information of the channel in these two cases are equal, i.e., I(x;y|H₁)=I(x;y|H₂).

Accordingly, the design of the quantized feedback strategies for a practical system involves dealing with a number of important factors such as non-optimal codes and an erroneous feedback link. The assumption of having an optimal code which performs close to the instantaneous mutual information of the channel is probably the most important factor that can adversely affect the performance of such a quantized feedback design if deployed in a practical system. If one neglects the effects of finite length code performance when searching for the optimal quantized feedback (by finding an estimate of the pdf of the equivalent channel quality and using it in a system with no feedback error), not only is it possible to not observe any performance improvement, it is also possible to witness a huge degradation in performance.

Hence, it is advantageous to apply the following design strategy. It is assumed that the system is available in order to be pre-evaluated prior to the actual deployment with quantized feedback. Therefore, we first evaluate the frame error probability of the overall system without feedback as a measure of the system performance for different average transmission powers. This evaluation incorporates the combined effect of the finite constellation size, modulation and demodulation scheme, and the performance of used outer (e.g., LDPC or turbo codes) and inner (e.g., space-time) codes. Next, we use this evaluated performance as our baseline to design a quantized feedback strategy.

It should be noted that we still benefit from the optimal analysis above. In particular, for a practical system, we use the channel ordering property and the defined measure for a system with the same model and infinite length codes. However, first, with this approach, we can use a channel ordering based on the outage measures described above, but we consider frame error probability using the same channel ordering as above that is not necessarily optimal. Second, we find the optimal power allocation for a given binning of the channel state information. However, this power allocation does not necessarily satisfy the power-threshold relation specified in the form of the optimal solution above since the bins are not necessarily optimal bins.

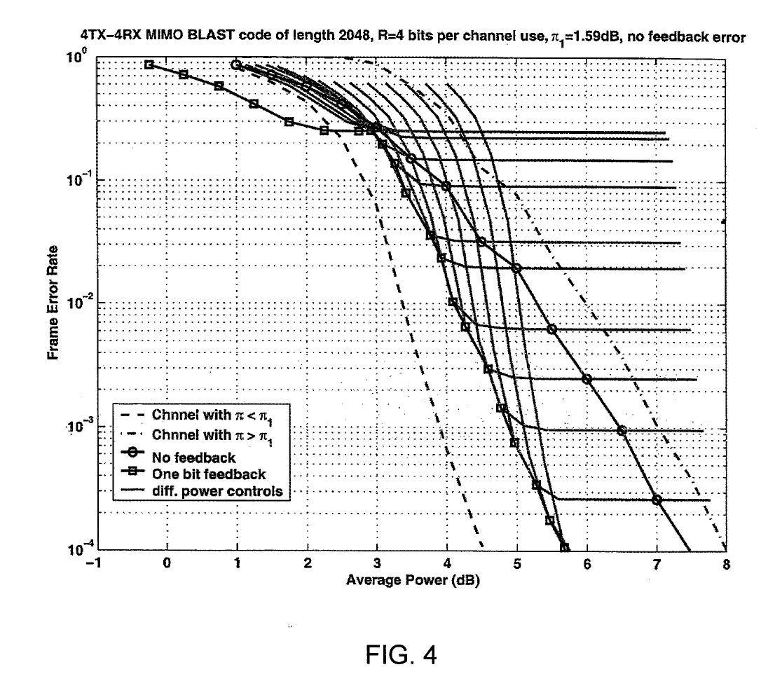

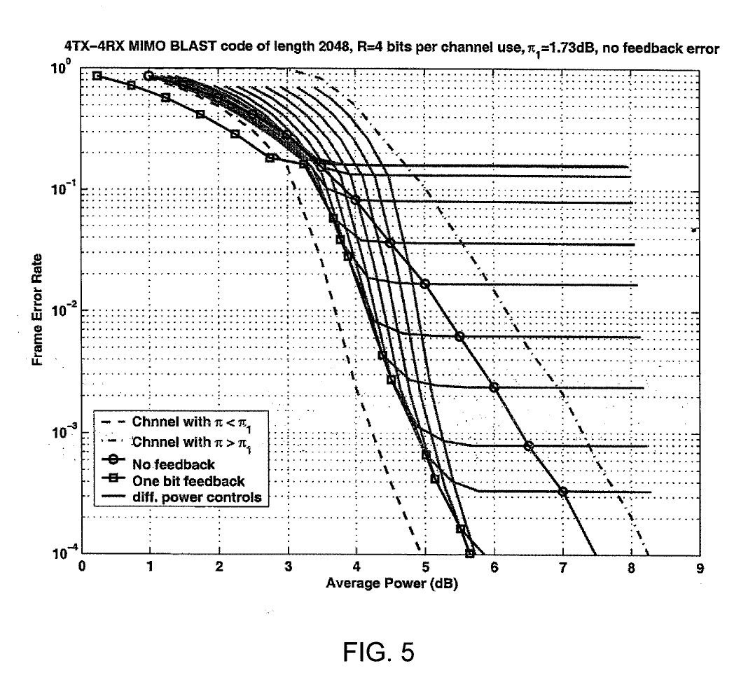

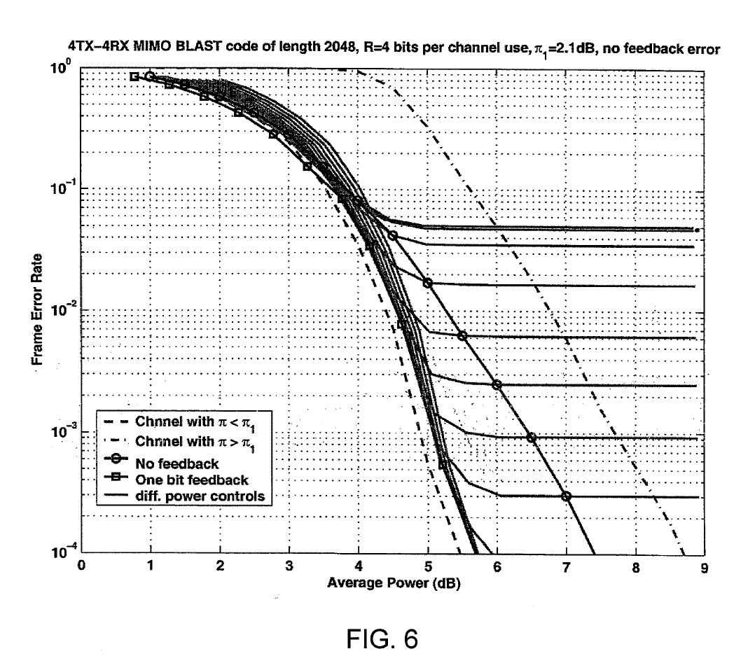

Consider the following example. Consider a 4×4 multiple antenna system which exploits a BLAST space time code of rate R=4 as in inner code which is concatenated with an LDPC outer code of length 2048 and rate ½. Therefore, the output of the LDPC encoder is divided into 4 independent streams and modulated with QPSK signals that are sent from 4 transmit antennas. To design a one bit feedback, we consider three different threshold for the equivalent one-dimensional channel quality η¹ as η₁, η₂, and η₃. The thresholds η₁, η₂, and η₃ for η can be equivalently expressed in terms of thresholds for the required average power to avoid outage which are denoted by π₁=1.59 dB, π₂=1.73 dB, and π₃=2.1 dB. These thresholds correspond to the F(η₁)=0.75, F(η₂)=0.85, F(η₃)=0.95, where F(η) is the cumulative distribution function of η. In the next step, we evaluate the performance of the system in each bin [0, π₁), [π₁, π₂), [π₂, π₃), and [π₃, ∞) that are denoted by B₁, B₂, B₃, and B₄, respectively. Since we are looking for a one bit feedback design, we combine the performance in the above four gins to find the performance for group G₁(π)=[0,π) and G₂(π)=[π, ∞) for three values of π=π₁, π₂, π₃. These performances are depicted in FIG. 4, 5, and 6, respectively with dashe lines. The performance of the group G₁(π) is better than the group G₂(π) for all values of the power threshold π as depicted in FIG. 4-6 because the channel conditions in group G₁(π) are better and consequently less power is needed to achieve the same frame error probability. It should be pointed out that the smoothness of the frame error probability versus the average in log-log domain can be used to extrapolate a continuous performance curve with a very good precision where only a small number of points on the curve is obtained through simulation. The probability distribution of the one dimensional channel quality gives us the probability of falling in each bin. For the current example, these probabilities are 0.75, 0.1, 0.1, 0.05 for the bin B₁, B₂, B₃, and B₄, respectively. Given these probabilities and the frame error probability curve versus average power for each group G₁(π) and G₂(π), we can calculate the system performance where a fixed power P₂ is assigned to the group G₂(π) versus the power P₁ that is used in group G₁(π). Now by varying P₂, we obtain a family of curves that are depicted with solid lines in FIG. 4-6. All the points in these curves are achievable with only specifying which one of two levels of power P₁ and P₂ should be used. Therefore, only one bit of feedback would be enough. On the other hand, the envelope of this family of curves, depicted in FIG. 4-6, provides the lower bound of the performance of one bit feedback design for the given threshold π and system definition. Therefore, the points in the envelope with their respective power levels P₁ and P₂ are the optimal points and power allocation for the given value of the threshold π.

By combining the performance results of the one-bit feedback for different threshold 7r and take the minimum of these curves, we reach the final design of the one bit feedback for the given set of threshold levels that are three threshold in our example. It should be noted that, for a given threshold level, the performance of the one-bit feedback design at low SNR is better when the threshold level is smaller. However, a small threshold ir incurs a performance loss for higher values of SNR. Therefore, for the current example, it is better to use the threshold π₁=1.59 dB at lower SNR values that correspond to higher frame error probabilities. As SNR increases and frame error probability decreases accordingly, we need to use the next value of the threshold π₁=1.73 dB, and finally we use the threshold π₁=2.1 dB. For a practical range of outage probability, a limited number of threshold levels would suffice to design a quantized feedback design because the performance curves are not very sensitive to the small changes in threshold. However, it should be noted although using two different threshold might result in the same performance for a given SNR, the power allocations in each bin are usually very different.

The same procedure for the design of the quantized feedback can be applied to a system with error in the feedback link. Although analysis of the error in the feedback link for an optimal system is not tractable, the presented design based on the pre-evaluated system performance can be used with a minimal change. Assuming that the probability of feedback error is known and is independent of the forward channel quality, we can calculate a new family of performance curves similar to the case that thereis no error in feedback link. However, because of the feedback error, a given power allocation P₁ and P₂ for the groups G₁(π) and G₂(π) will result in a higher frame error rate higher SNR. It can be observed that the higher the threshold π, the more robust the performance with respect to the error in the feedback link. In other words, the performance degradation with erroneous feedback happens at lower frame error rate when the threshold 7r is higher. It should be noted that although the design of a quantized feedback with a given error rate in feedback link is similar to the design without error in the feedback link, the resulting power allocation will not be the same. Thus, where feedback link error is probable, it should be accounted for in the design stage in order to avoid a possibly huge degradation in performance.

It should be pointed out that although the disclosed design scheme performs binning based on the percentage of the probability that the channel quality lie in each bin (which has proved to be effective in practice), other binning techniques could be readily used. Increasing the number of bins potentially increases the performance of the design; however, the pre-evaluation step becomes more tedious. On the other hand, using a less number of bits not only makes the off-line pre-evaluation and quantized feedback design done faster, but it also makes the design more robust to changes in average received SNR.

While exemplary drawings and specific embodiments of the present invention have been described and illustrated, it is to be understood that that the scope of the present invention is not to be limited to the particular embodiments discussed. Thus, the embodiments shall be regarded as illustrative rather than restrictive, and it should be understood that variations may be made in those embodiments by workers skilled in the arts without departing from the scope of the present invention as set forth in the claims that follow and their structural and functional equivalents.

### Appendix

THEOREM: Let P(γ) ε P,P={P₁, P₂, . . . , P_{L}} be the optimal solution for the optimization problem (10), where P₁>P₂> . . . >P_{L}. Then, for all γ except in a set of measure zero
∀i, 1≦i≦L−1: P(γ)=PᵢPᵢ₊₁<P*(γ)≦Pᵢ
otherwise P(γ)=P_{L}, i.e., [symbol] P*(γ)≦P_{L} or P₁<P*(γ)

PROOF: Let Pₒᵤₜ(γ, R, P(γ)) represents the outage event for a given channel condition γ, the transmitted power P(γ), and the attempted rate of transmission R, i.e., Pₒᵤₜ(γ, R, P(γ))=1 if the rate R is greater than the instantaneous mutual information of the channel with fixed channel quality γ using transmit power P(γ), and Pₒᵤₜ(γ, R, P(γ))=0 otherwise.

First, we note that (i) ∀γ ε ∪ᵢ₌₁^{L-1}Γᵢ: Pₒᵤₜ(γ₀,R,P(γ₀))=0. Suppose not, then there exist some γ₀ ε ∪ᵢ₌₁^{L-1}Γᵢ: such that Pₒᵤₜ(γ₀,R,P(γ₀))=1. We can remove γ₀ from the set ∪ᵢ₌₁^{L-1}Γᵢ and assign it to Γ_{L} without changing the overall outage probability. However, the average transmission power is lower than (or equal to) the case that γ₀ ε ∪ᵢ₌₁^{L-1}Γᵢ. Note that the average transmission power is strictly smaller for all non-degenerate points, i.e., f_{γ}(γ₀)≠0, i.e., the channel condition γ₀ is a degenerate point. Therefore, we can satisfy Condition (i) by reassigning all such points γ₀ to the set Γ_{L}.

Second, we note that (ii) ∀γ if ∃i<L−1: P(γ)=Pᵢ then Pₒᵤₜ(γ,R,Pᵢ₊₁)=1. Suppose not, therefore there exists γ₀ and i such that P(γ₀)=Pᵢ and P_{out(γ}₀,R,Pᵢ₊₁)=0. We can reassign γ₀ to the set Γᵢ₊₁ instead of Γᵢ and therefore P(γ₀)=Pᵢ₊₁. With this repartitioning, the total outage probability of the system is not changed, however, the total average power is smaller (or might be equal in a degenerate case f_{γ}(γ₀)=0). Clearly, this repartitioning satisfies Condition (ii).

Therefore, without loss of generality we assume that the optimal solution satisfies Conditions (i) and (ii). In fact, if for some specific choice of coding or channel coefficients distribution, any other solution also minimizes the outage probability for the same average power, it can be equivalently transformed to such a solution which satisfies both Condition (i) and (ii).

Now, we can easily prove the theorem. Consider γ such that Pᵢ₊₁<P*(γ)≦Pᵢ for some i, 1≦i≦L−1. We want to show that P(γ)=Pᵢ, or equivalently γ ε Γᵢ. Assume that γ ε Γⱼ for some 1<j<i. This is in contradiction with Condition (ii) because Pₒᵤₜ(γ,R,Pᵢ)=0. Also, we cannot have γ 68 Γⱼ for some i<j≦L−1, because Pₒᵤₜ(γ,R,Pⱼ)=1 that is in contradiction with Condition (i). Now, it is only left to show that γ∉Γ_{L} except for a set of measure zero. Let Γᵢ* be defined as a set of all γ such that Pᵢ₊₁<P*(γ)≦Pᵢ, and assume that the set Γᵢ*-Γᵢ has nonzero probability. Therefore, we can find a new power level Pᵢ′<Pᵢ and partition the set Γᵢ* into two new sets Γᵢ′Δ{γ, Pᵢ₊₁<P*(γ)≦Pᵢ′} in which the power Pᵢ′ will be used, and the set Γᵢ*-Γᵢ′ in which power P_{L}′ will be used. This repartitioning will not change the outage probability, but reduces the average power which is in contradiction with the optimality of the original solution. Therefore, the channel quality γ has to be in Γᵢ* that means Pᵢ₊₁<P*(γ)≦Pᵢ. The sufficiency condition can also be similarly argued, because if P(γ)=Pᵢ for some i, 1≦i≦L−1, it has to provides zero outage due to Condition (i), and therefore, P*(γ)≦Pᵢ. Moreover, the power Pᵢ₊₁ cannot be enough to have no outage because of the Condition (ii), and therefore Pᵢ₊₁<P*(γ).

Now, we note that the only regions that are left from the set of possible γ's are P*(γ)≦P_{L} and P₁<P*(γ) that constitute the last partition γ_{L} for which P(γ)=P_{L}. This completes the proof.

What is claimed is:

1. A method for power control in a multiple antenna communication system, the method comprising:
estimating channel conditions between a receiver and a transmitter; and
selecting one out of a plurality of power level partitions for transmission using a feedback link back to the transmitter based on the estimated channel conditions, the plurality of power levels partitioned so as to avoid outage probability in all of the power level partitions except one of the plurality of power level partitions.

2. The method of claim 1 wherein the channel conditions are represented in the power allocation by an equivalent one-dimensional channel condition.

3. The method of claim 1 wherein a pre-evaluation of the multiple-antenna communication system was performed based on the frame error probability of the system.

4. A receiver implementing power control in a multiple antenna communication system, the receiver comprising:
a channel estimator for estimating channel conditions between the receiver and a transmitter; and
a feedback link selector which selects one out of a plurality of power level partitions for transmission using a feedback link back to the transmitter based on the estimated channel conditions, the plurality of power levels partitioned so as to avoid outage probability in all of the power level partitions except one of the plurality of power level partitions.
